(19) United States
(12) Patent Application Publication
(10) Pub. No.: US 2026/0133462 A1
(43) Pub. Date: May 14, 2026

(54) OPTICAL SIGNAL GENERATION DEVICE AND OPTICAL SIGNAL GENERATION METHOD

(71) Applicant: NTT, Inc., Tokyo (JP)

(72) Inventors: Hiroto KAWAKAMI, Musashino-shi (JP); Masanori NAKAMURA, Musashino-shi (JP); Yutaka MIYAMOTO, Musashino-shi (JP)

(73) Assignee: NTT, Inc., Tokyo (JP)

(21) Appl. No.: 19/119,616

(22) PCT Filed: Oct. 14, 2022
(86) PCT No.: PCT/JP2022/038404

§ 371 Date: Apr. 9, 2025

(51) Int. Cl. G02F 1/21; G02F 1/225; H04B 10/54

(52) U.S. Cl. CPC G02F 1/212; G02F 1/225; H04B 10/541

(57) ABSTRACT

An optical modulator is a Mach-Zehnder interferometer that branches light, inputs the light to first and second Mach-Zehnder type optical modulators, and combines the light outputted by each of the first and second Mach-Zehnder type optical modulators to generate a QAM signal. The first and second drive signal application electrodes change optical path lengths of first and second arms of the first Mach-Zehnder type optical modulator in accordance with first and second drive signals that are multi-level electric signals, respectively. The third and fourth drive signal application electrodes change the optical path lengths of the first and second arms of the second Mach-Zehnder type optical modulator in accordance with third and fourth drive signals that are multi-level electric signals, respectively. First to fourth drive signal generation units generate the first to fourth drive signals and apply them to the first to fourth drive signal application electrodes, respectively. The first to fourth drive signals are multi-level signals independent of each other.

### TECHNICAL FIELD

The present invention relates to an optical signal generation device and an optical signal generation method.

### BACKGROUND ART

In high-speed and large-capacity optical transmission systems, multi-level signal, particularly, optical QAM (Quadrature Amplitude modulation) having information on optical phase and optical intensity, are widely used. In order to increase the transmission capacity, it is important to increase an order of an optical QAM signal.

An optical IQ modulator is widely used for generating the optical QAM signal. FIG. 7 is a diagram showing the structure of an optical IQ modulator 90 used in an optical modulation signal generation device 9 and drive system thereof of the conventional technique. Usually, the optical IQ modulator is configured by a nested structure in which two Mach-Zehnder modulators are arranged on each of two arms of another Mach-Zehnder interferometer. The optical IQ modulator 90 shown in FIG. 7 has a configuration in which one Mach-Zehnder modulator 91 is arranged on each of two arms of the Mach-Zehnder interferometer 20.

CW (Continuous Wave) light is inputted to an input terminal of the optical IQ modulator 90. A splitting unit 21 of the Mach-Zehnder interferometer 20 branches the inputted CW light and outputs each of the branched CW light to the Mach-Zehnder modulators 91 of each arm. One among the two Mach-Zehnder modulators 91 is used to generate an In-Phase optical signal, and the other one is used to generate a Quadrature-Phase optical signal. The former is referred to as an I signal Mach-Zehnder modulator 91a, and the latter is referred to as a Q signal Mach-Zehnder modulator 91b, in the present application. In addition, each output optical electric fields of the I signal Mach-Zehnder modulator 91a and the Q signal Mach-Zehnder modulator 91b is denoted as E_{I} and E_{Q}, respectively. The optical electric field E_{I} of the I signal Mach-Zehnder modulator 91a and the optical electric field E_{Q} of the Q signal Mach-Zehnder modulator 91b are combined by a combining unit 22 of the Mach-Zehnder interferometer 20, and the optical QAM signal is generated.

In this case, strict adjustment is required for an optical path difference between two arms of two Mach-Zehnder modulators 91 and an optical path difference between two arms of Mach-Zehnder interferometer 20. That is, when wavelength of CW light is set to λ, the optical path difference ΔL between the two arms of I signal Mach-Zehnder modulator 91a is λ/2, the optical path difference ΔL between the two arms of Q signal Mach-Zehnder modulator 91 b is also λ/2, and the optical path difference ΔL between the two arms of Mach-Zehnder interferometer 20 for combining E_{I} and E_{Q} is λ/4 at a moment when drive signal is not applied at all. Here, the optical path difference is not a geometrical difference in optical path length. A shift of the optical phase in the combining unit 22 of the Mach-Zehnder interferometer 20 and delay due to a change of a refractive index of the arm generated when the drive signal is applied to each Mach-Zehnder modulator 91 are also treated as the optical path difference.

Next, a description will be given of a state in which the drive signal is applied to each Mach-Zehnder modulator 91. Since the optical path difference between the two arms of each Mach-Zehnder modulator 91 changes and interference intensity also changes, optical modulation is performed.

In order to drive the Mach-Zehnder modulator 91, an electrode for applying the drive signal is required. Although there is a plurality of types for arranging the electrode, in the present application, a case where the Mach-Zehnder modulator 91 is a dual drive type Mach-Zehnder modulator will be described.

In order to apply the drive signal to input light, a first I signal drive electrode 12a-1 is arranged on one arm among the two arms of the I signal Mach-Zehnder modulator 91a, and a second I signal drive electrode 12a-2 is arranged on the other arm. Opposite signals are applied to the first I signal drive electrode 12a-1 and the second I signal drive electrode 12a-2. Here, these are referred to as V_{Ip} and V_{In}, respectively. In the case of a lithium niobate type optical modulator, the drive signal takes positive and negative voltages, and V_{Ip}=−V_{In} is satisfied. In the case of a semiconductor type modulator, an offset voltage is applied to both of V_{Ip} and V_{In} to set only the positive voltage or the negative voltage. In either case, V_{Ip} and V_{In} change every moment in accordance with a pattern of the signal to be generated. In the conventional technique, when the optical path length of one arm is increased by V_{Ip}, the optical path length of the other arm is decreased by V_{In}, and when the optical path length of one arm is decreased by V_{Ip}, the optical path length of the other arm is increased by V_{In} (for example, see PTL 1).

When generating V_{Ip} and V_{In}, an I signal DAC (Digital Analog converter) 93a first generates a multi-level electric signal. An output of the I signal DAC 93a is amplified by an I signal differential amplifier 94a, and V_{Ip} and V_{In} are generated. An amplitude of V_{Ip} and an amplitude of V_{In} are set to be equal to each other. When the amplitudes of V_{Ip} and V_{In} are increased, the modulation efficiency is increased, but when the amplitude is increased to a certain extent or more, the modulation efficiency is decreased. The amplitudes of V_{Ip} and V_{In} which the maximum modulation efficiency is obtained are determined by a half-wavelength voltage V_{π}. The amplitude is +V_{π}/2 to −V_{π}/2 in the lithium niobate type optical modulator. As described above, since V_{Ip}=−V_{In} is satisfied in the lithium niobate type optical modulator of the conventional configuration, when V_{Ip} is +V_{π}/2, V_{In} is −V_{π}/2. A state in which the modulation efficiency becomes the maximum is expressed as 100% swing in the present application.

The same configuration is adopted for the Q signal Mach-Zehnder modulator 91b. That is, a Q signal DAC 93b generates the multi-level electric signal, and a Q signal differential amplifier 94b amplifies an output from the Q signal DAC 93b to generate V_{Qp} and V_{Qn}. V_{Qp}=−V_{Qn} is satisfied.

Here, when the I signal DAC 93a and the Q signal DAC 93b generate independent n-level electric signals, the number of symbols held by the optical QAM signal generated by the optical IQ modulator 90 is n².

FIG. 8 are diagrams showing the optical electric fields E_{I} and E_{Q} in the case where n is 4 and an optical electric field E_{I}+E_{Q} outputted from the optical IQ modulator 90 on a complex plane in 100% swing. FIG. 8(a) shows EI, FIG. 8(b) shows E_{Q}, and FIG. 8(c) shows E_{I}+E_{Q}. A vertical axis and a horizontal axis are standardized so that E_{I} and E_{Q} are at most ±2 in 100% swing. A 16-QAM is generated by a vector sum of E_{I}+E_{Q}. A symbol farthest from an origin among symbols of E_{I}+E_{Q} shown in FIG. 8(c) is located at a position of 2×2^{0.5}. It should be noted here that, in the case of 100% swing, the 16-level symbols are not uniformly arranged. This is due to sine wave characteristics of the Mach-Zehnder interferometer. In order to arrange each symbol uniformly, a drive amplitude is usually set to be smaller than 100% swing (for example, see NPL 1).

FIG. 9 are diagrams showing, in a 50% swing obtained by reducing the drive amplitude to a half, the optical electric fields E_{I} and E_{Q} in the case where n is 4 and the optical electric field E_{I}+E_{Q} outputted from the optical IQ modulator 90 on the complex plane. FIG. 9(a) shows E_{I}, FIG. 9(b) shows E_{Q}, and FIG. 9(c) shows E_{I}+E_{Q}. From FIG. 9(c), it can be seen that each symbol of the 16-QAM is substantially equal. However, as compared with FIG. 8(c), all the symbols of the QAM approach the origin, and as a result, the optical power of the optical QAM signal becomes small. In other words, a modulation loss is increased.

In the above description, it is assumed that each symbol of the QAM signal is arranged in a lattice shape, and an existence probability of each symbol is not specifically mentioned. A symbol far from the origin of the complex plane has a strong light intensity, and deterioration due to a nonlinear optical effect is likely to occur in an optical transmission line. For this reason, there has been proposed a configuration in which no symbol is arranged at a position far from the origin of the complex plane or the probability that a symbol existing at a position far from the origin of the complex plane is selected is reduced. In such configuration, it has been already known that it is desirable that the probability distribution of the presence of the symbol with respect to the distance from the origin becomes a Gaussian distribution (for example, see NPL 2).

### CITATION LIST

### Patent Literature

PTL 1: Japanese U.S. Pat. No. 5,261,779

### Non Patent Literature

NPL 1: H. Kawakami and others, “Auto bias control and bias hold circuit for IQ-modulator in flexible optical QAM transmitter with Nyquist filtering”, OpticsExpress, Vol. 22, No. 23, pp. 28163-28168, 2014.

NPL 2: Zhen Qu and others, “On the Probabilistic Shaping and Geometric Shaping in Optical Communication Systems”, IEEE Access, vol. 7, pp. 21454-21464, 2019.

### SUMMARY OF INVENTION

### Technical Problem

In the conventional technique shown in FIG. 7 to FIG. 9, there is a problem described below. First, in order to increase the multi-level number, resolutions of the I signal DAC and the Q signal DAC must be increased. However, increasing the resolution while maintaining the linearity of the DAC and keeping a high operating speed makes circuit production difficult.

Next, the magnitude of the optical electric field is limited even when the swing is 100%, as shown in FIG. 8. Therefore, the optical power of the optical QAM signal is limited, and the optical signal-to-noise ratio is also limited. In particular, as shown in FIG. 9, when the drive amplitude is reduced to increase the linearity, the modulation loss increases, and the optical signal-to-noise ratio is further deteriorated.

In addition, in the conventional technique, in order to make a probability distribution in which N symbols of the generated N-QAM signal exist close to a Gaussian distribution, there is a problem in which complicated processing is required, such that the resolution M of the DAC is set high, and N pieces of selection is performed from positions of M² symbols that can be generated (where M>N is satisfied) or frequency of selecting the symbol in the vicinity of the origin when mapping data to the symbol is increased.

In view of the above circumstances, an object of the present invention is to provide an optical signal generation device and an optical signal generation method capable of generating an optical QAM signal having more symbols without using a drive system which is difficult to produce.

### Solution to Problem

An optical signal generation device of one aspect of the present invention includes an optical modulator, that is a Mach-Zehnder interferometer, that branches light, inputs the branched light to each of a first Mach-Zehnder type optical modulator and a second Mach-Zehnder type optical modulator, and combines the light outputted from the first Mach-Zehnder type optical modulator and the light outputted from the second Mach-Zehnder type optical modulator to generate a QAM signal, a first drive signal application electrode that changes an optical path length of a first arm among the first arm and a second arm of the first Mach-Zehnder type optical modulator in accordance with a first drive signal that is a multi-level electric signal, a second drive signal application electrode that changes the optical path length of the second arm of the first Mach-Zehnder type optical modulator in accordance with a second drive signal that is the multi-level electric signal, a third drive signal application electrode that changes the optical path length of a first arm among the first arm and a second arm of the second Mach-Zehnder type optical modulator in accordance with a third drive signal that is the multi-level electric signal, a fourth drive signal application electrode that changes the optical path length of the second arm of the second Mach-Zehnder type optical modulator in accordance with a fourth drive signal that is the multi-level electric signal, a first drive signal generation unit that generates the first drive signal and applies the first drive signal to the first drive signal application electrode, a second drive signal generation unit that generates the second drive signal and applies the second drive signal to the second drive signal application electrode, a third drive signal generation unit that generates the third drive signal and applies the third drive signal to the third drive signal application electrode, and a fourth drive signal generation unit that generates the fourth drive signal and applies the fourth drive signal to the fourth drive signal application electrode, wherein the first drive signal, the second drive signal, the third drive signal, and the fourth drive signal are multi-level signals independent of each other.

An optical signal generation device of one aspect of the present invention includes a Mach-Zehnder type optical modulator that branches light, inputs the branched light to each of a first arm and a second arm, and combines the light outputted from the first arm and the light outputted from the second arm to generate a QAM signal, a first drive signal application electrode that changes an optical path length of the first arm in accordance with a first drive signal that is a multi-level electric signal, a second drive signal application electrode that changes the optical path length of the second arm in accordance with a second drive signal that is the multi-level electric signal, a first drive signal generation unit that generates the first drive signal and applies the first drive signal to the first drive signal application electrode, and a second drive signal generation unit that generates the second drive signal and applies the second drive signal to the second drive signal application electrode, wherein the first drive signal and the second drive signal are multi-level signals independent of each other.

An optical signal generation method of one aspect of the present invention includes a branching step of branching light and inputting the branched light to a first Mach-Zehnder type optical modulator and a second Mach-Zehnder type optical modulator, a first drive signal generation step of generating a first drive signal that is a multi-level electric signal, a second drive signal generation step of generating a second drive signal that is the multi-level electric signal, a third drive signal generation step of generating a third drive signal that is the multi-level electric signal, a fourth drive signal generation step of generating a fourth drive signal that is the multi-level electric signal, a first application step of changing an optical path length of a first arm among the first arm and a second arm of the first Mach-Zehnder type optical modulator by a first drive signal application electrode in accordance with the first drive signal, a second application step of changing the optical path length of the second arm of the first Mach-Zehnder type optical modulator by a second drive signal application electrode in accordance with the second drive signal, a third application step of changing the optical path length of a first arm among the first arm and the second arm of the second Mach-Zehnder type optical modulator by a third drive signal application electrode in accordance with the third drive signal, a fourth application step of changing the optical path length of the second arm of the second Mach-Zehnder type optical modulator by a fourth drive signal application electrode in accordance with the fourth drive signal, and a combining step of combining the light outputted by the first Mach-Zehnder type optical modulator and the light outputted by the second Mach-Zehnder type optical modulator to generate a QAM signal, wherein the first drive signal, the second drive signal, the third drive signal, and the fourth drive signal are multi-level signals independent of each other.

An optical signal generation method of one aspect of the present invention includes a branching step of branching light, inputting the branched light to each of a first arm and a second arm of a Mach-Zehnder type optical modulator, a first drive signal generation step of generating a first drive signal that is a multi-level electric signal, a second drive signal generation step of generating a second drive signal that is the multi-level electric signal, a first application step of changing an optical path length of the first arm by a first drive signal application electrode in accordance with the first drive signal, a second application step of changing an optical path length of the second arm by a second drive signal application electrode in accordance with the second drive signal, and a combining step of combining the light outputted from the first arm and the light outputted from the second arm to generate a QAM signal, wherein the first drive signal and the second drive signal are multi-level signals independent of each other.

### Advantageous Effects of Invention

According to the present invention, an optical QAM signal having more symbols can be generated without using a drive system which is difficult to produce.

### BRIEF DESCRIPTION OF DRAWINGS

FIG. 1 A diagram showing a configuration of an optical modulation signal generation device of a first embodiment.

FIG. 2 A diagram showing an optical electric field of an optical IQ modulator of the first embodiment.

FIG. 3 A diagram showing an optical electric field of an optical IQ modulator of a second embodiment.

FIG. 4 A diagram showing an optical electric field of an optical IQ modulator of a third embodiment.

FIG. 5 A diagram showing an optical electric field of an optical IQ modulator of a variation of the third embodiment.

FIG. 6 A diagram showing an optical electric field of an optical IQ modulator of a fourth embodiment.

FIG. 7 A diagram showing a configuration of an optical modulation signal generation device of the conventional technique.

FIG. 8 A diagram showing an optical electric field of an optical IQ modulator of the conventional technique.

FIG. 9 A diagram showing an optical electric field of the optical IQ modulator of the conventional technique.

### DESCRIPTION OF EMBODIMENTS

Hereinafter, embodiments of the present invention will be described in detail with reference to the drawings. Note that the same parts in a plurality of drawings will be denoted by the same reference numerals and description thereof will be omitted. The present embodiment relates to an optical signal generation device for generating an optical modulation signal by using an external modulator. An object of the present embodiment is to provide a technique for generating an optical QAM signal having more symbols by a DAC having a smaller resolution, suppressing influence of sine wave characteristics of a modulator, and reducing a modulation loss. Further, an object of the present embodiment is to provide a technique capable of freely setting an existence probability distribution of symbols with respect to a distance from an origin of a complex plane even in a DAC having a small resolution.

### First Embodiment

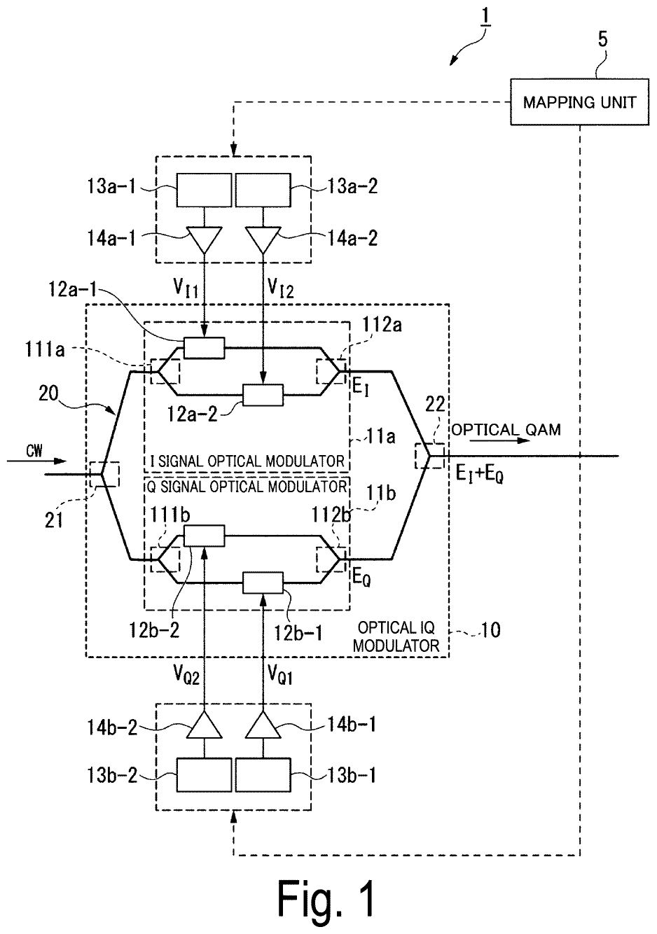

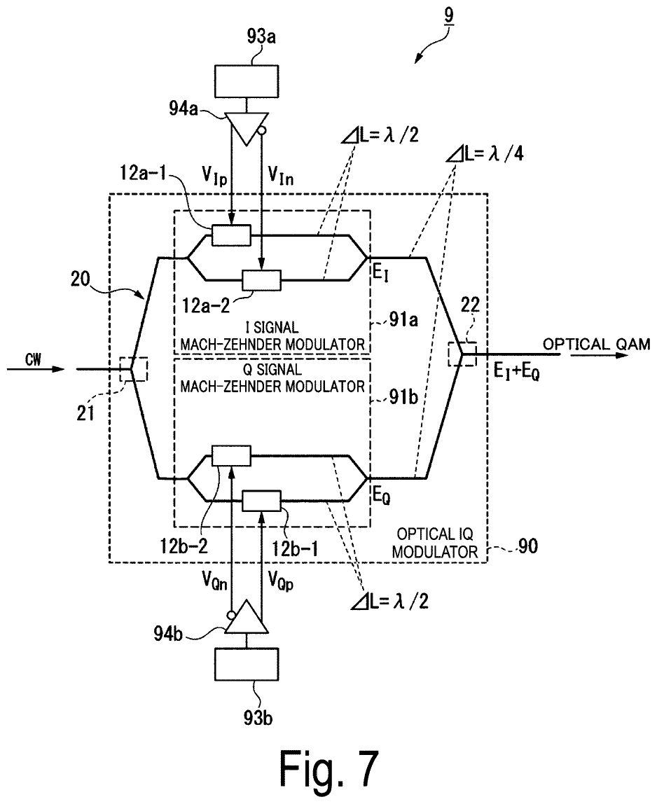

FIG. 1 is a diagram showing a configuration of an optical modulation signal generation device 1 in a first embodiment. The optical modulation signal generation device 1 is one example of an optical signal generation device. In FIG. 1, the same parts as those of an optical modulation signal generation device 9 shown in FIG. 7 are designated by the same reference numerals. The optical modulation signal generation device 1 has an optical IQ modulator 10 and a drive system of the optical IQ modulator 10. The drive system has a first I signal DAC 13a-1, a second I signal DAC 13a-2, a first Q signal DAC 13b-1, a second Q signal DAC 13b-2, a first I signal amplifier 14a-1, a second I signal amplifier 14a-2, a first Q signal amplifier 14b-1, and a second Q signal amplifier 14b-2.

The optical IQ modulator 10 is configured by arranging one optical modulator 11 on each of two arms of a Mach-Zehnder interferometer 20. The optical modulator 11 is a Mach-Zehnder type optical modulator. The optical modulator 11 used for generating an In-Phase optical signal is denoted as an I signal optical modulator 11a, and the optical modulator 11 used for generating a Quadrature-Phase optical signal is denoted as a Q signal optical modulator 11b. Here, a case where the optical modulator 11 is a dual drive type Mach-Zehnder optical modulator will be described, as an example. In this case, the I signal optical modulator 11a and the Q signal optical modulator 11b have the same configuration as those of the I signal Mach-Zehnder modulator 91a and the Q signal Mach-Zehnder modulator 91b shown in FIG. 7, respectively. A first I signal drive electrode 12a-1 is arranged on one arm among two arms of the I signal optical modulator 11a, and a second I signal drive electrode 12a-2 is arranged on the other arm. A first Q signal drive electrode 12b-1 is arranged on one arm among two arms of the Q signal optical modulator 11b, and a second Q signal drive electrode 12b-2 is arranged on the other arm.

With the above-described configuration, independent drive signals V_{I1} and V_{I2} are respectively applied to the first I signal drive electrode 12a-1 and the second I signal drive electrode 12a-2 included in the I signal optical modulator 11a. The drive signal V_{I1} applied to the first I signal drive electrode 12a-1 is generated by amplifying an output of the first I signal DAC 13a-1 by the first I signal amplifier 14a-1. The drive signal V_{I2} applied to the second I signal drive electrode 12a-2 is generated by amplifying an output of the second I signal DAC 13a-2 by the second I signal amplifier 14a-2.

The same also applies to the Q signal optical modulator 11b. That is, the drive signal V_{Q1} applied to the first Q signal drive electrode 12b-1 is generated by amplifying the output of the first Q signal DAC 13b-1 by the first Q signal amplifier 14b-1. The drive signal V_{Q2} applied to the second Q signal drive electrode 12b-2 is generated by amplifying the output of the second Q signal DAC 13b-2 by the second Q signal amplifier 14b-2. Therefore, in the present embodiment, a total of four types of drive signals of V_{I1}, V_{I2}, V_{Q1}, and V_{Q2}, are applied to one optical IQ modulator 10, and they are multi-level signals independent of each other.

Here, operations of the optical IQ modulator 10 will be described. The optical IQ modulator 10 inputs CW light. A splitting unit 21 of a Mach-Zehnder interferometer 20 branches the inputted CW light, outputs one branched light to an I signal optical modulator 11a, and outputs the other branched light to a Q signal optical modulator 11b.

The splitting unit 111a of the I signal optical modulator 11a branches the light inputted from the splitting unit 21, outputs one branched light to an arm where the first I signal drive electrode 12a-1 is arranged, and outputs the other branched light to an arm where the second I signal drive electrode 12a-2 is arranged. The first I signal drive electrode 12a-1 changes the optical path length of the arm by the drive signal V_{I1} outputted by the first I signal amplifier 14a-1, and the second I signal drive electrode 12a-2 changes the optical path length of the arm by the drive signal V_{I2} outputted by the second I signal amplifier 14a-2. A combining unit 112a of the I signal optical modulator 11a combines the light transmitted through the two arms, respectively, and outputs the combined light.

Similarly, a splitting unit 111b of the Q signal optical modulator 11b branches the light inputted from the splitting unit 21, outputs one branched light to an arm where the first Q signal drive electrode 12b-1 is arranged, and outputs the other branched light to an arm where the second Q signal drive electrode 12b-2 is arranged. The first Q signal drive electrode 12b-1 changes the optical path length of the arm by the drive signal V_{Q1} outputted by the first Q signal amplifier 14b-1, and the second Q signal drive electrode 12b-2 changes the optical path length of the arm by the drive signal V_{Q2} outputted by the second Q signal amplifier 14b-2. A combining unit 112b of the Q signal optical modulator 11b combines the light transmitted through the two arms, respectively, and outputs the combined light.

A combining unit 22 of the Mach-Zehnder interferometer 20 combines the light outputted by the combining unit 112a of the I signal optical modulator 11a and the light outputted by the combining unit 112b of the Q signal optical modulator 11b, and outputs an optical QAM signal generated by combining from the optical IQ modulator 10.

Note that when the drive signal is not applied at all, the optical path difference ΔL between the two arms of the I signal optical modulator 11a and the optical path difference ΔL between the two arms of the Q signal optical modulator 11b are λ/2, and the optical path difference ΔL between the two arms of the Mach-Zehnder interferometer 20 is λ/4. The output optical electric field of the I signal optical modulator 11a is defined as E_{I}, and the output optical electric field of the Q signal optical modulator 11b is defined as E_{Q}. The output optical electric field from the optical IQ modulator 10 is E_{I}+E_{Q}.

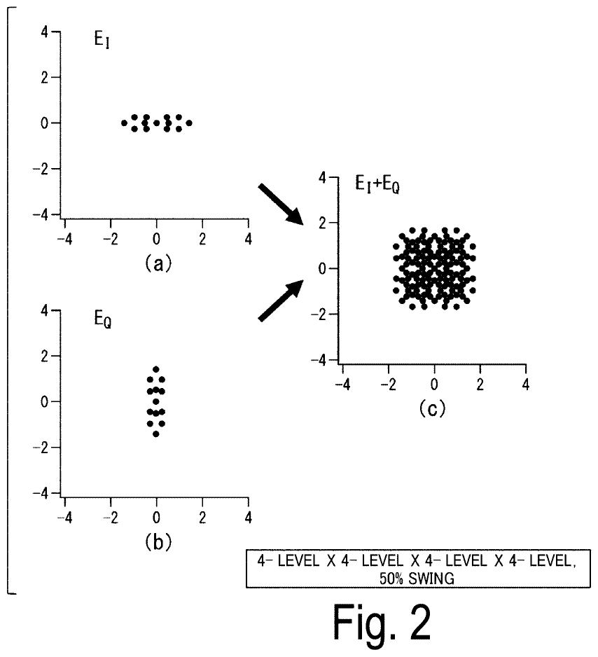

Here, it is assumed that all of the drive signals of V_{I1}, V_{I2}, V_{Q1}, and V_{Q2} are four-level and 50% swing. FIG. 2 are diagrams showing the optical electric fields E_{I} and E_{Q} obtained at this time and the optical electric field E_{I}+E_{Q} outputted from the optical IQ modulator 10 on a complex plane. FIG. 2(a) shows E_{I}, FIG. 2(b) shows E_{Q}, and FIG. 2(c) shows E_{I}+E_{Q}.

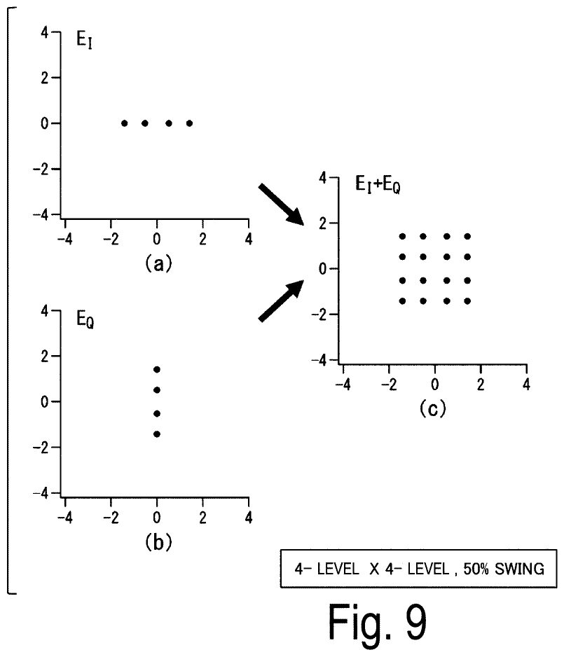

Because the drive signals are not complementary, the optical electric field E_{I} and the optical electric field E_{Q} are not arranged in a straight line on the complex plane. As shown in FIG. 2(a), there are 16 combinations in the optical electric field E_{I}, but 13 symbols are generated because a part of combination overlaps on the complex plane. As shown in FIG. 2(b), 13 symbols are similarly generated for the optical electric field E_{Q}. As shown in FIG. 2(c), in the optical electric field E_{I}+E_{Q} outputted from the optical IQ modulator 10, the number of independent symbols reaches 169. Outputs of respective DACs of the first I signal DAC 13a-1, the second I signal DAC 13a-2, the first Q signal DAC 13b-1, and the second Q signal DAC 13b-2 are four-level, in addition, although the conventional optical IQ modulator 10 is used, the modulation order is remarkably increased as compared with the result in which the modulation order is 16 in the conventional configuration shown in FIG. 9. These 169 symbols may be used to obtain a 169-QAM, or a 64-QAM can be operated by not using symbols that are too close together. In this case, the drive system outputs the drive signal having the value corresponding to the symbol used for operation.

As shown in FIG. 1, the optical modulation signal generation device 1 may internally or externally include a mapping unit 5 for mapping data and symbols to be used. The mapping unit 5 controls the drive system so as to generate a drive signal for generating the symbol mapped to the data.

### Second Embodiment

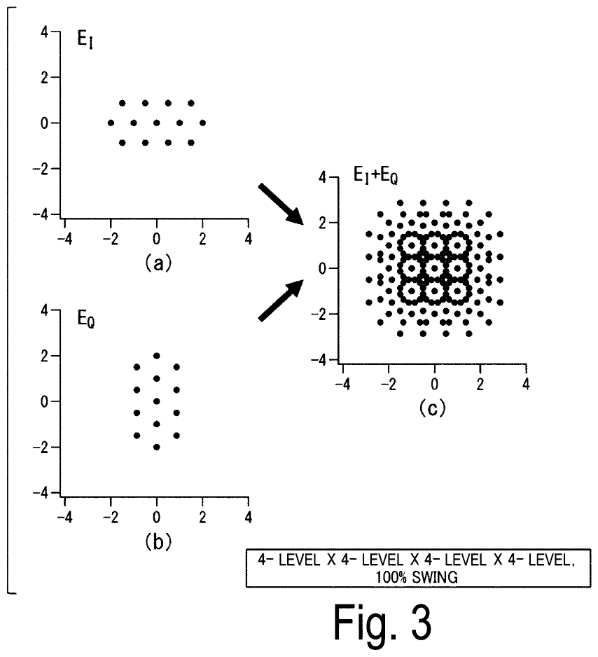

A second embodiment will be described focusing on the differences from the first embodiment. A configuration of an optical modulation signal generation device of the second embodiment is the same as that of the optical modulation signal generation device 1 shown in FIG. 1. However, the amplitudes of four types of drive signals of V_{I1}, V_{I2}, V_{Q1}, and V_{Q2} are 100%. FIG. 3 are diagrams showing optical electric fields E_{I} and E_{Q} obtained in the optical IQ modulator 10 of the present embodiment and an optical electric field E_{I}+E_{Q} outputted from the optical IQ modulator 10 on the complex plane in this case. FIG. 3(a) shows E_{I}, FIG. 3(b) shows E_{Q}, and FIG. 3(c) shows E_{I}+E_{Q}.

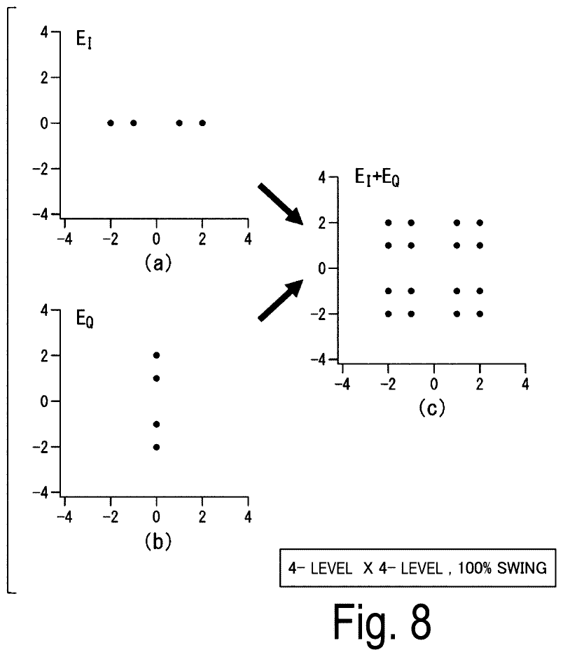

As shown in FIG. 3(c), in 100% swing, the unequal intervals between symbols become conspicuous, as in the case of the optical electric field of the conventional technique shown in FIG. 8. However, since the number of symbols is sufficiently large, the QAM signal in which symbols are arranged at equal intervals can be generated by not using symbols that are too close together. It should be noted in FIG. 3(c) that, unlike FIG. 8(c), in the optical electric field E_{I}+E_{Q}, the position of the symbol farthest from the origin exceeds 2×2^{0.5}. This is because an angle formed by E_{I} and E_{Q} on the complex plane is not limited to a right angle but may be an acute angle. Therefore, although the conventional type optical IQ modulator 10 is used, the modulation order can be increased and the modulation loss can be reduced.

In addition, another one point to be noted in FIG. 3(c) is that the existence probability of the symbol decreases as the distance from the origin increases in the optical electric field E_{I}+E_{Q}. This means that the probability that the optical signal has a high instantaneous intensity becomes low. Therefore, when the optical IQ modulator 10 generates the 169-QAM by using all of the 169 symbols, optical noise caused by the nonlinear optical effect in the transmission line can be reduced.

In addition, in the case where 64 symbols are selected from the 169 symbols and the optical IQ modulator 10 generates a 64-QAM optical signal, the optical IQ modulator 10 may be configured to perform the selection, so that the existence probability distribution of the 64 symbols with respect to the distance from the origin approaches the Gaussian distribution. The drive system outputs the drive signal for generating the selected symbol. The mapping unit 5 may control the drive system so as to map the data to the selected symbols and generate the drive signal for generating these symbols.

### Third Embodiment

A third embodiment will be described by focusing on a difference from the embodiments described above. In the configuration of the optical modulation signal generation device described in the above embodiment, when two natural numbers M and N satisfy M≥N, N symbols are selected from M symbols that E_{I}+E_{Q} can take on the complex plane, and data is mapped to them to generate an N-QAM signal. However, the remaining M−N symbols have not been described at all.

When Nyquist filtering is applied to the optical QAM signal, or when pre-emphasis is used for correcting waveform deterioration on the optical transmission line and waveform distortion of an electric circuit, it is necessary to appropriately generate an optical electric field in an intermediate transition state in the process of changing from a symbol to another symbol. In other words, in order to generate an optical N-QAM signal using such complicated processing, it is essential to generate more kinds of optical electric fields than N. Ideally, although the electric drive signal has a discrete and finite multi-level number, it is desirable that arbitrary values can be selected in an analogue manner for the optical phase and the optical intensity of the optical electric field to be outputted. In the optical modulation signal generation device of the present embodiment, the kinds of the optical phase and the optical intensity of the optical signal to be generated are overwhelmingly larger than the multi-level number of the drive signal. Therefore, a state close to the ideal condition described above can be achieved.

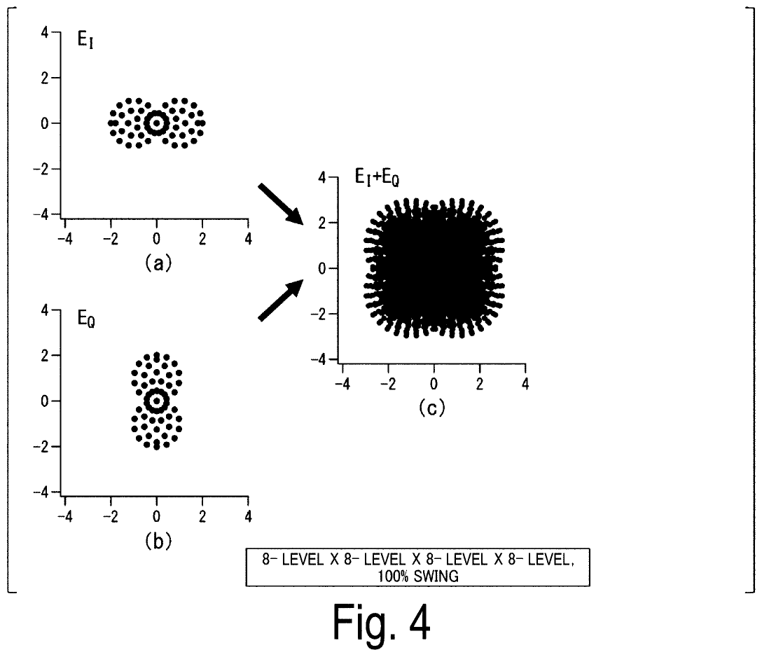

The configuration of the optical modulation signal generation device of the third embodiment is the same as that of the optical modulation signal generation device 1 shown in FIG. 1. However, the amplitudes of four types of drive signals of V_{I1}, V_{I2}, V_{Q1}, and V_{Q2} are set to 100%, and each drive signal is set to eight-level. FIG. 4 are diagrams showing the optical electric fields E_{I} and E_{Q} obtained in the optical IQ modulator 10 of the present embodiment and the optical electric field E_{I}+E_{Q} outputted from the optical IQ modulator 10 on the complex plane in this case. FIG. 4(a) shows E_{I}, FIG. 4(b) shows E_{Q}, and FIG. 4(c) shows E_{I}+E_{Q}.

As shown in FIG. 4, when the coordinates of the horizontal axis and the vertical axis are within ±2, the symbols of E_{I}+E_{Q} are arranged very densely. Therefore, it can be seen that the optical phase and the optical intensity can be generated in an analogue manner.

### Variation of Third Embodiment

When two natural numbers M and N satisfies M>N, the optical modulation signal generation device can generate an N-QAM signal by selecting more than N symbols from M symbols that E_{I}+E_{Q} can take on the complex plane and mapping data to them in a multi-to-one manner. In this case, it is necessary to strictly determine the correspondence rule, but an advantage described above is obtained. A configuration of an optical modulation signal generation device of the present embodiment is the same as that of the optical modulation signal generation device 1 of the first embodiment shown in FIG. 1.

The first I signal amplifier 14a-1, the second I signal amplifier 14a-2, the first Q signal amplifier 14b-1, and the second Q signal amplifier 14b-2 are signal amplifiers for generating a drive signal. When an output waveform of the signal amplifier is observed at a specific moment, whether the amplitude is large or small is determined by a pattern of the signal to be generated. Since the linearity of the signal amplifier is limited, the waveform of the drive signal to be generated tends to be distorted when the output change is large. On the other hand, when the output of the signal amplifier continues to be in a substantially constant state for a long time, the waveform of the drive signal is also easily distorted due to the low-frequency cut-off of the amplifier. However, by performing mapping in the multi-to-one manner as in the present embodiment, it is possible to select the symbol so that the change amount in the output waveform of the signal amplifier is always appropriate.

In addition, by performing the mapping in the multi-to-one manner, it is possible to preferentially select the symbol close to the origin of the complex plane in a transmission line having a large optical nonlinear effect, and to preferentially select the symbol far from the origin of the complex plane in a transmission line having a large background noise.

For example, the mapping unit 5 monitors output waveforms of the first I signal DAC 13a-1, the second I signal DAC 13a-2, the first Q signal DAC 13b-1, and the second Q signal DAC 13b-2, and selects a symbol to be used among a plurality of symbols corresponding to data so that a change amount of the output waveform is within a range of a predetermined appropriate size. Alternatively, the mapping unit 5 monitors the transmission line and selects a symbol to be used among the plurality of symbols corresponding to the data on the basis of the optical nonlinear effect or background noise of the transmission line. The mapping unit 5 controls the drive system so as to generate the drive signal for generating the selected symbol. In this way, the correspondence between the data and the symbol may be changed in accordance with the state of the transmission line and the signal pattern.

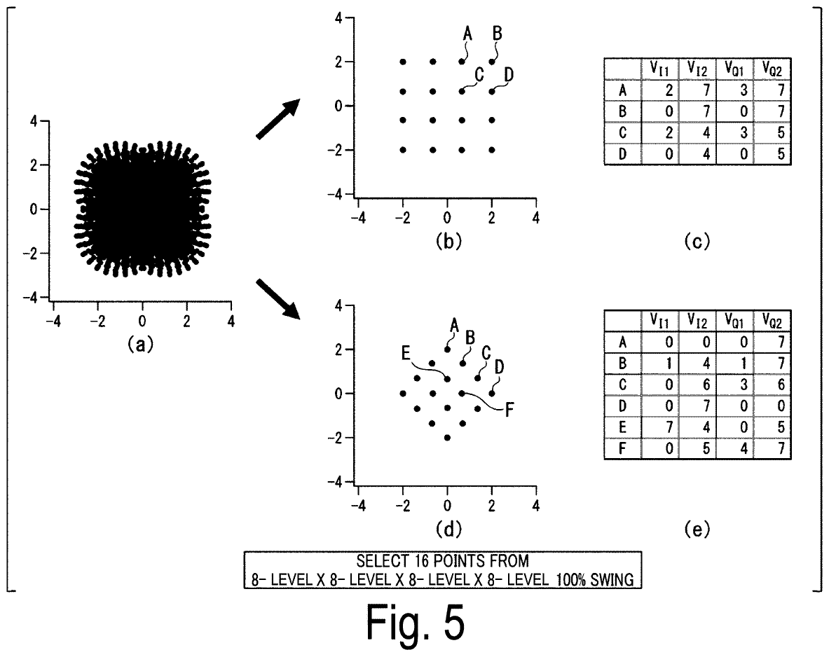

FIG. 5 is a diagram showing an example of selecting the symbol. FIG. 5 shows two examples in which 16 symbols are selected from a number of symbols that E_{I}+E_{Q} can take on the complex plane and the optical IQ modulator 10 generates the selected 16-QAM signal. In FIG. 5(a), similarly to that shown in FIG. 4, the amplitudes of the four types of drive signals of V_{I1}, V_{I2}, V_{Q1}, and V_{Q2} are set to 100% swing (−V_{π}/2 to +V_{π}/2), and these drive signals are set to eight-level. There are combinations of drive signals of 8⁴=4096. FIG. 5(b) shows a first example in which 16 kinds are selected among the 84 combinations of drive signals and the optical IQ modulator 10 generates 16 QAM by the selected combination of 16. Here, in FIG. 5(c), with respect to the four symbols A to D included in the first quadrant of the complex plane shown in FIG. 5(b), the values taken by V_{I1}, V_{I2}, V_{Q1}, and V_{Q2} are shown in a table. In this table, the eight-level of the drive signal is expressed by 0 to 7, where 0 corresponds to −V_{π}/2 and 7 corresponds to +V_{π}/2.

FIG. 5(d) shows a second example in which 16 kinds of drive signals different from those of FIG. 5(b) are selected among the 8⁴ combinations of drive signals, and the optical IQ modulator 10 generates the 16 QAM by another combination of 16 kinds selected. In the example shown in FIG. 5(d), the optical IQ modulator 10 generates the 16 QAM having a smaller maximum distance from the origin than that in the example shown in FIG. 5(b) and inclined by 45 degrees to indicate a freedom degree of constellation generation. In FIG. 5(e), with respect to six symbols A to F included in a first quadrant (including a boundary line) shown in FIG. 5(d), the values taken by V_{I1}, V_{I2}, V_{Q1}, and V_{Q2} are shown in a table similar to FIG. 5(c). As can be seen from FIG. 5, the optical modulation signal generation device 1 of the present embodiment can generate various QAM signals extremely flexibly from the drive signals of eight-level at most.

### Fourth Embodiment

In the above-described embodiments, the conventional optical IQ modulator is used to apply four types of independent drive signals. However, focusing on the optical electric field E_{I} shown in FIG. 4 and FIG. 3, it can be seen that the optical electric field E_{I} can also be utilized as an irregular optical QAM signal. In this case, it is not necessary to use the optical IQ modulator 10, and a single Mach-Zehnder type optical modulator can be used.

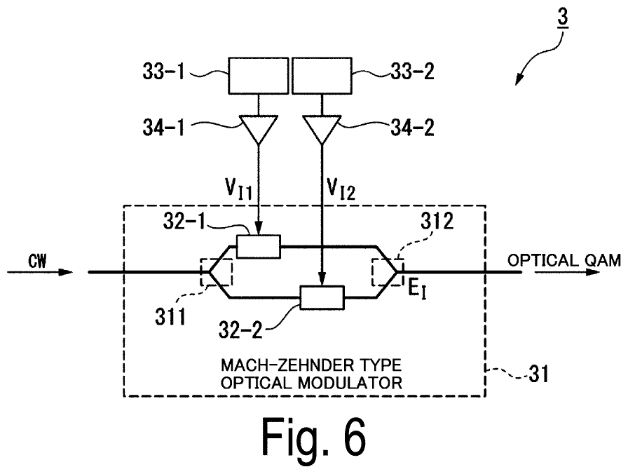

FIG. 6 is a diagram showing a configuration of an optical modulation signal generation device 3 according to a fourth embodiment. The optical modulation signal generation device 3 is one example of the optical signal generation device. The optical modulation signal generation device 3 includes a Mach-Zehnder type optical modulator 31, a first signal DAC 33-1, a second signal DAC 33-2, a first signal amplifier 34-1, and a second signal amplifier 34-2. A first signal drive electrode 32-1 is arranged on one arm among two arms of the Mach-Zehnder type optical modulator 31, and a second signal drive electrode 32-2 is arranged on the other arm. A drive signal V_{I1} applied to the first signal drive electrode 32-1 is generated by amplifying an output of the first signal DAC 33-1 by the first signal amplifier 34-1. A drive signal V_{I2} applied to the second signal drive electrode 32-2 is generated by amplifying an output of the second signal DAC 33-2 by the second signal amplifier 34-2. The drive signals V_{I1} and V_{I2} are multi-level signals independent of each other.

A splitting unit 311 of the Mach-Zehnder type optical modulator 31 branches the inputted CW light, outputs one branched light to the arm where the first signal drive electrode 32-1 is arranged, and outputs the other branched light to the arm where the second signal drive electrode 32-2 is arranged. The first signal drive electrode 32-1 changes the optical path length of the arm by the drive signal V_{I1} outputted from the first signal amplifier 34-1 and the second signal drive electrode 32-2 changes the optical path length of the arm by the drive signal V_{I2} outputted from the second signal amplifier 34-2. A combining unit 312 of the Mach-Zehnder type optical modulator 31 combines the light transmitted through the two arms, respectively, and outputs the light of the combined optical electric field E_{I}.

The optical modulation signal generation device 3 is nothing other than the configuration of the optical modulation signal generation device 1 of the first embodiment shown in FIG. 1, in which the Q signal optical modulator 11b and drive system thereof are removed and only two types of drive signals are applied to the I signal optical modulator 11a only. In this configuration, the modulation order is remarkably reduced as compared with the other embodiments, there is an advantage that the optical QAM signal can be generated by the single Mach-Zehnder type optical modulator.

According to the optical signal generation device of the present embodiment, it is possible to generate a QAM signal having a larger number of symbols by using a DAC having a lower resolution than that of the conventional technique, suppress influence of sine wave characteristics of the optical IQ modulator, and reduce the modulation loss. In addition, according to the optical signal generation device of the present embodiment, it is possible to freely set the existence probability distribution of the symbol with respect to the distance from the origin of the complex plane even in a DAC having a small resolution.

According to the above-described embodiments, the optical signal generation device includes an optical modulator, first to fourth drive signal application electrodes, and first to fourth drive signal generation units. The optical signal generation device corresponds to, for example, the optical modulation signal generation device 1 of the embodiment. In addition, for example, the optical modulator corresponds to the optical IQ modulator 10 of the embodiment. Further, for example, the first drive signal application electrode corresponds to the first I signal drive electrode 12a-1 of the embodiment, the second drive signal application electrode corresponds to the second I signal drive electrode 12a-2 of the embodiment, the third drive signal application electrode corresponds to the first Q signal drive electrode 12b-1 of the embodiment, and the fourth drive signal application electrode corresponds to the second Q signal drive electrode 12b-2 of the embodiment. Furthermore, for example, the first drive signal generation unit corresponds to the first I signal DAC 13a-1 and the first I signal amplifier 14a-1 of the embodiment, the second drive signal generation unit corresponds to the second I signal DAC 13a-2 and the second I signal amplifier 14a-2 of the embodiment, the third drive signal generation unit corresponds to the first Q signal DAC 13b-1 and the first Q signal amplifier 14b-1 of the embodiment, and the fourth drive signal generation unit corresponds to the second Q signal DAC 13b-2 and the second Q signal amplifier 14b-2 of the embodiment.

The optical modulator is a Mach-Zehnder interferometer that branches light, inputs the branched light to each of the first Mach-Zehnder type optical modulator and the second Mach-Zehnder type optical modulator, and combining the light outputted by the first Mach-Zehnder type optical modulator and the light outputted by the second Mach-Zehnder type optical modulator to generate a QAM signal. The first drive signal application electrode changes the optical path length of the first arm among the first arm and the second arm of the first Mach-Zehnder type optical modulator in accordance with the first drive signal that is the multi-level electric signal. The second drive signal application electrode changes the optical path length of the second arm of the first Mach-Zehnder type optical modulator in accordance with the second drive signal that is the multi-level electric signal. The third drive signal application electrode changes the optical path length of the first arm among the first arm and the second arm of the second Mach-Zehnder type optical modulator in accordance with the third drive signal that is the multi-level electric signal. The fourth drive signal application electrode changes the optical path length of the second arm of the second Mach-Zehnder type optical modulator in accordance with the fourth drive signal that is the multi-level electric signal. The first drive signal generation unit generates the first drive signal and applies it to the first drive signal application electrode. The second drive signal generation unit generates the second drive signal and applies it to the second drive signal application electrode. The third drive signal generation unit generates the third drive signal and applies it to the third drive signal application electrode. The fourth drive signal generation unit generates the fourth drive signal and applies it to the fourth drive signal application electrode. The first drive signal generation unit, the second drive signal generation unit, the third drive signal generation unit, and the fourth drive signal generation unit generate the first drive signal, the second drive signal, the third drive signal, and the fourth drive signal of multi-level signal independent of each other.

When the natural numbers L, M and N satisfy M≥L≥N, the optical signal generation device may associate L symbols selected from M symbols that the optical electric field combined by the optical modulator can take on the complex plane with N kinds of data in the one-to-one manner or multiple-to-one manner and generate an L-QAM signal to which N kinds of data are mapped.

In addition, the L symbols may be selected such that the existence probability distribution with respect to the distance of the L symbols from the origin of the complex plane approaches the Gaussian.

Further, the correspondence between the L symbols and the N kinds of data may be changed in accordance with the state of the transmission line or the signal pattern.

An optical signal generation device includes a Mach-Zehnder type optical modulator, first and second drive signal application electrodes, and first and second drive signal generation units. For example, the optical signal generation device corresponds to the optical modulation signal generation device 3 of the embodiment, and the Mach-Zehnder type optical modulator corresponds to the Mach-Zehnder type optical modulator 31 of the embodiment. The first drive signal application electrode corresponds to the first signal drive electrode 32-1 of the embodiment, and the second drive signal application electrode corresponds to the second signal drive electrode 32-2 of the embodiment. In addition, for example, the first drive signal generation unit corresponds to the first signal DAC 33-1 and the first signal amplifier 34-1, and the second drive signal generation unit corresponds to the second signal DAC 33-2 and the second signal amplifier 34-2. The Mach-Zehnder type optical modulator branches light, inputs the branched light to each of the first arm and the second arm, and combines the light outputted from the first arm and the light outputted from the second arm to generate a QAM signal. The first drive signal application electrode changes the optical path length of the first arm in accordance with a first drive signal that is a multi-level electric signal. The second drive signal application electrode changes the optical path length of the second arm in accordance with a second drive signal that is the multi-level electric signal. The first drive signal generation unit generates the first drive signal and applies it to the first drive signal application electrode. The second drive signal generation unit generates the second drive signal and applies it to the second drive signal application electrode. The first drive signal generation unit and the second drive signal generation unit generate the first drive signal and the second drive signal of multi-level signal independent of each other.

Although the embodiment of this invention has been described above in detail with reference to the drawings, a specific configuration is not limited to this embodiment and design within the scope of the gist of this invention, and the like are included.

### Industrial Applicability

The present invention is applicable to an optical transmitter for generating an optical QAM signal.

### Reference Signs List

1, 3, 9 Optical modulation signal generation device
5 Mapping unit
10, 90 Optical IQ modulator
11a I signal optical modulator
11b Q signal optical modulator
12a-1 First I signal drive electrode
12a-2 Second I signal drive electrode
12b-1 First Q signal drive electrode
12b-2 Second Q signal drive electrode
13a-1 First I signal DAC
13a-2 Second I signal DAC
13b-1 First Q signal DAC
13b-2 Second Q signal DAC
14a-1 First I signal amplifier
14a-2 Second I signal amplifier
14b-1 First Q signal amplifier
14b-2 Second Q signal amplifier
20 Mach-Zehnder interferometer
21, 111a, 111b, 311 Splitting unit
22, 112a, 112b, 312 Combining unit
31 Mach-Zehnder type optical modulator
33-1 First signal DAC
33-2 Second signal DAC
34-1 First signal amplifier
34-2 Second signal amplifier
91a I signal Mach-Zehnder modulator
91b Q signal Mach-Zehnder modulator
93a I signal DAC
93b Q signal DAC
94a I signal differential amplifier
94b Q signal differential amplifier

1. An optical signal generation device comprising:
an optical modulator, that is a Mach-Zehnder interferometer, configured to branch light into first and second branched light, input the first branched light to a first Mach-Zehnder type optical modulator which includes a first arm and a second arm, input the second branched light to a second Mach-Zehnder type optical modulator which includes a third arm and a fourth arm, and combine first output light outputted from the first Mach-Zehnder type optical modulator and second output light outputted from the second Mach-Zehnder type optical modulator to generate a QAM signal;
a first drive signal application electrode configured to change a first optical path length of the first arm of the first Mach-Zehnder type optical modulator in accordance with a first drive signal that is a multi-level electric signal;
a second drive signal application electrode configured to change a second optical path length of the second arm of the first Mach-Zehnder type optical modulator in accordance with a second drive signal that is the multi-level electric signal;
a third drive signal application electrode configured to change a third optical path length of the third arm of the second Mach-Zehnder type optical modulator in accordance with a third drive signal that is the multi-level electric signal;
a fourth drive signal application electrode configured to change a fourth optical path length of the fourth arm of the second Mach-Zehnder type optical modulator in accordance with a fourth drive signal that is the multi-level electric signal;
a first drive signal generator configured to generate the first drive signal and apply the first drive signal to the first drive signal application electrode;
a second drive signal generator configured to generate the second drive signal and apply the second drive signal to the second drive signal application electrode;
a third drive signal generator configured to generate the third drive signal and apply the third drive signal to the third drive signal application electrode; and
a fourth drive signal generator configured to generate the fourth drive signal and apply the fourth drive signal to the fourth drive signal application electrode, wherein
the first drive signal, the second drive signal, the third drive signal, and the fourth drive signal are multi-level signals independent of each other.

2. An optical signal generation device comprising:
a Mach-Zehnder type optical modulator configured to branch light, input the branched light to each of a first arm and a second arm, and combine first output light outputted from the first arm and second output light outputted from the second arm to generate a QAM signal;
a first drive signal application electrode configured to change a first optical path length of the first arm in accordance with a first drive signal that is a multi-level electric signal;
a second drive signal application electrode configured to change a second optical path length of the second arm in accordance with a second drive signal that is the multi-level electric signal;
a first drive signal generator configured to generate the first drive signal and apply the first drive signal to the first drive signal application electrode; and
a second drive signal generator configured to generate the second drive signal and apply the second drive signal to the second drive signal application electrode, wherein
the first drive signal and the second drive signal are multi-level signals independent of each other.

3. An optical signal generation method comprising:
branching light into first and second branched light, inputting the first branched light to a first Mach-Zehnder type optical modulator which includes a first arm and a second arm and inputting the second branched light to a second Mach-Zehnder type optical modulator which includes a third arm and a fourth arm;
generating a first drive signal that is a first multi-level electric signal;
generating a second drive signal that is a second multi-level electric signal;
generating a third drive signal that is a third multi-level electric signal;
generating a fourth drive signal that is a fourth multi-level electric signal;
changing a first optical path length of the first arm of the first Mach-Zehnder type optical modulator by a first drive signal application electrode in accordance with the first drive signal;
changing a second optical path length of the second arm of the first Mach-Zehnder type optical modulator by a second drive signal application electrode in accordance with the second drive signal;
changing a third optical path length of the third arm of the second Mach-Zehnder type optical modulator by a third drive signal application electrode in accordance with the third drive signal;
changing a fourth optical path length of the fourth arm of the second Mach-Zehnder type optical modulator by a fourth drive signal application electrode in accordance with the fourth drive signal; and
combining first output light outputted by the first Mach-Zehnder type optical modulator and second output light outputted by the second Mach-Zehnder type optical modulator to generate a QAM signal, wherein
the first drive signal, the second drive signal, the third drive signal, and the fourth drive signal are multi-level signals independent of each other.

4. (canceled)

5. The optical signal generation method according to claim 3, further comprising:
when natural numbers L, M, and N satisfy M≥L≥N, selecting L symbols from M symbols that an optical electric field of the combined light can take on a complex plane, and mapping N kinds of data to L symbols in a one-to-one manner or multiple-to-one manner to generate an L-QAM signal.

6. The optical signal generation method according to claim 5, wherein
the L symbols are selected so that an existence probability distribution with respect to a distance of the L symbols from an origin of the complex plane approaches Gaussian.

7. The optical signal generation method according to claim 5, wherein
correspondence between the L symbols and the N kinds of data is changed in accordance with a state of a transmission line or a signal pattern.
